(19) United States
(12) Patent Application Publication
(10) Pub. No.: US 2011/0271351 A1
(43) Pub. Date: Nov. 3, 2011

(54) Method and System for Site Based Information Distribution

(76) Inventor: André Rautenberg, Bottrop (DE)

(21) Appl. No.: 13/037,286

(22) Filed: Feb. 28, 2011

Related U.S. Application Data
(60) Provisional application No. 61/328,644, filed on Apr. 28, 2010.

(51) Int. Cl. H04L 9/00; H04L 9/32

(52) U.S. Cl. 726/26

(57) ABSTRACT

A method and a system include an account site for establishing at least one information account. The information account is established by supplying at least a secret transfer key where the information account is associated with an account identifier. Information is entered into the information account, where the information is encoded before storage into the information account and is viewable only by an owner of the information account. Access permission is entered for at least one requester to enable transfer of the information to an account of the requester. The requester is contacted for at least making available the information. The secret transfer key is communicated to the requester where the secret transfer key is used by the requester to retrieve the information. The information is decoded, transferred to an account of the requester and a log entry of the transfer is made into the information account.

### CROSS-REFERENCE TO RELATED APPLICATIONS

The present Utility patent application claims priority benefit of the U.S. provisional application for patent Ser. No. 61328644 entitled “A System, Method and Means for Internet Based Information Distribution”, filed on 28, Apr. 2010, under 35 U.S.C. 119(e). The contents of this related provisional application are incorporated herein by reference for all purposes.

### FEDERALLY SPONSORED RESEARCH OR DEVELOPMENT

### Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the flow of information provided and transferred via the Internet or global network. More particularly, the present invention relates to a method and means for distributing information which provides an information owner control over and access to information associated with the owner.

### BACKGROUND OF THE INVENTION

The present invention may operate to provide a website for storing, processing and distributing information associated with the Internet or global network. Information associated with the present invention may include financial information requiring a high-level of security and effective distribution. Two types of parties operating via the Internet may be directly affected by information transfer: information requesters and information owners. Information requestors may be individuals or companies needing information to drive their business (EBay, Amazon, etc.) with users registering and providing their information (Address, banking account, credit card number, etc.) to the information requestors. Furthermore, information requesters may be uncertain as to the validity of the information provided by users. Information owners may be individuals or companies operating to provide access to information via the Internet. Information owners may experience difficulties associated with distributed data administration and with missing transparency. Furthermore, these difficulties associated with the use of information may result from providing the same information via several different web sites

FIG. 1 presents an illustration for the typical flow of information associated with the Internet, in accordance with the prior art.

An information flow 100 includes a multiplicity of information owners with a sampling denoted as an information owner 101 and a multiplicity of websites with a sampling denoted as a website 103.

Information flow 100 may operate to enable communication between a multiplicity of users and a multiplicity of website devices.

Information owner 101 may seek to interact with a website or websites. Information owner 101 may desire to post and receive information via a website or websites.

Website 103 may operate as an Internet website for receiving and presenting information to a user or users or other website device or website devices.

As an example, information owner 101 may operate to communicate bi-directionally with website 103.

A multiplicity of information owners may access a multiplicity of websites for requesting or providing information. Information flow may be considered as being transferred from information owner to information requester. The information presented via websites may be provided by information owners. Information requesters seek to retrieve the latest information. Furthermore, information owners typically desire to post, modify and edit their information via a single website instead of several different websites. It is therefore an objective of the present invention to act as an intermediary between information owners and information requesters for facilitating the flow of information via the Internet or global network.

In view of the foregoing, there is a need for improved techniques for distributing information via the Internet that generally guarantees the validity of the information and provides information owners with centralized data distribution and control over and knowledge associated with the transfer of information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 presents an illustration for the typical flow of information associated with the Internet, in accordance with the prior art;

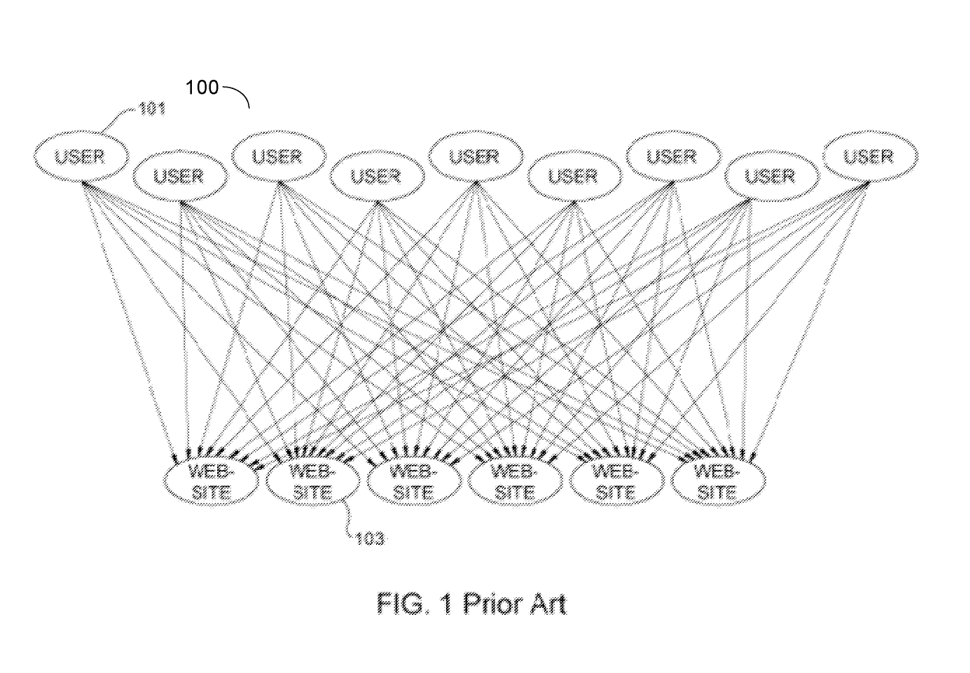

FIG. 2 presents an illustration of the exemplary flow of information via the Internet using an information account website, in accordance with an embodiment of the present invention;

FIG. 3 presents a block diagram illustrating an exemplary account associated with an information account website, in accordance with an embodiment of the present invention;

FIG. 4 presents a flowchart illustrating an exemplary process enabling an information owner to add and modify information associated with his/her account, in accordance with an embodiment of the present invention;

FIG. 5 presents a flowchart illustrating an exemplary process enabling an information owner with the capability to modify an access list associated with of his/her account, in accordance with an embodiment of the present invention;

FIG. 6 presents a flowchart illustrating an exemplary process enabling an information requester with the capability to retrieve information from an information account website, in accordance with an embodiment of the present invention; and

FIG. 7 presents an illustration of a typical computer system that, when appropriately configured or designed, may serve as a computer system for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a method and a system for site based information distribution is presented.

In one embodiment a method includes steps for accessing an account site for establishing at least one information account, steps for establishing the information account by supplying at least a secret transfer key, steps for entering information into the information account, where the information is viewable only by an owner of the information account, steps for entering access permission to enable transfer of the information to an account of a requester, steps for contacting the requester for at least making available the information, and steps for communicating the secret transfer key to the requester where the secret transfer key is used by the requester to retrieve the information and a log entry of the retrieval is made into the information account. Another embodiment further includes steps for accessing the information account for editing of the information. Yet another embodiment further includes steps for accessing the information account to view the log entry.

In another embodiment a method includes the steps of accessing an account site for establishing at least one information account. The information account is established by supplying at least a secret transfer key where the information account is associated with an account identifier. Information is entered into the information account, where the information is encoded before storage into the information account and is viewable only by an owner of the information account. Access permission is entered for at least one requester to enable transfer of the information to an account of the requester. The requester is contacted for at least making available the information. The secret transfer key is communicated to the requester where the secret transfer key is used by the requester to retrieve the information where the information is decoded, transferred to an account of the requester and a log entry of the transfer is made into the information account. Another embodiment further includes the step of accessing the information account for editing of the information where the edited information is encoded before storage. In yet another embodiment the edited information and the account identifier is further transferred to the account of the requester after the edited information and the account identifier is encoded. Still another embodiment further includes the step of accessing the information account to view the log entry. In another embodiment the account of the requester resides at the account site. In yet another embodiment the information remains viewable only by the owner of the information account during the decoding and transferring to the account of the requester. In still another embodiment the step of establishing further comprises supplying a personal identifier for access to the information account. In another embodiment the requester supplies a personal identifier for access to the account of the requester.

In another embodiment a system includes an account site being operable for establishing and maintaining a plurality of information accounts. An owner information account is established and maintained at the account site where the owner information account is operable for maintaining at least information that an owner desires to make available to selected requesters. The owner information account further being operable for encoding and storing the information, a secret transfer key, access permissions, and an account identifier. The owner information account further being operable for maintaining the information viewable only by the owner. A requester account is established and maintained at the account site where the requester account is operable for receiving a transfer of information from the owner information account. The requester account further being operable for verifying a validity of a secret transfer key communicated to a user of the requester account from the owner where upon presentation of a valid secret transfer key by the user, the requester account is further operable for decoding the information and recording a log entry in the owner information account of a transfer of at least part of the information. In another embodiment the requester account is further operable for decoding the account identifier to determine a location for the log entry. In yet another embodiment the owner information account is further operable for enabling the owner to edit the information. In still another embodiment the owner information account is further operable for enabling the owner to edit the access permissions. In another embodiment the edited information and the account identifier is further transferred to the requester account after the edited information and the account identifier is encoded. In yet another embodiment the owner information account is further operable for enabling the owner to view the log entry. In still another embodiment the information remains viewable only by the owner of the information account during transferring to the requester account. In another embodiment the owner supplies a personal identifier for access to the information account. I yet another embodiment the requester supplies a personal identifier for access to the requester account.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention may operate to provide an account or profile for enabling an information owner to distribute information via the Internet and provide the information owner authorization-control and access-logging for distributed information. An information owner may operate to provide information in an account or profile and grant access to specific information requesters. Furthermore, embodiments may provide information owners with minimization of the distributed data administration and provide information requesters with valid data. The method of sharing information for embodiments may be differentiated from prior art methods since one account may not read information from another account, even when granted access rights. Instead, the information may be transferred to a requester's account, in a manner similar to currency being transferred as associated with bank accounts. Furthermore, decoding of the information may be performed prior to the requester receiving access. Furthermore, an information owner may view which information has been received by a requester or requestors.

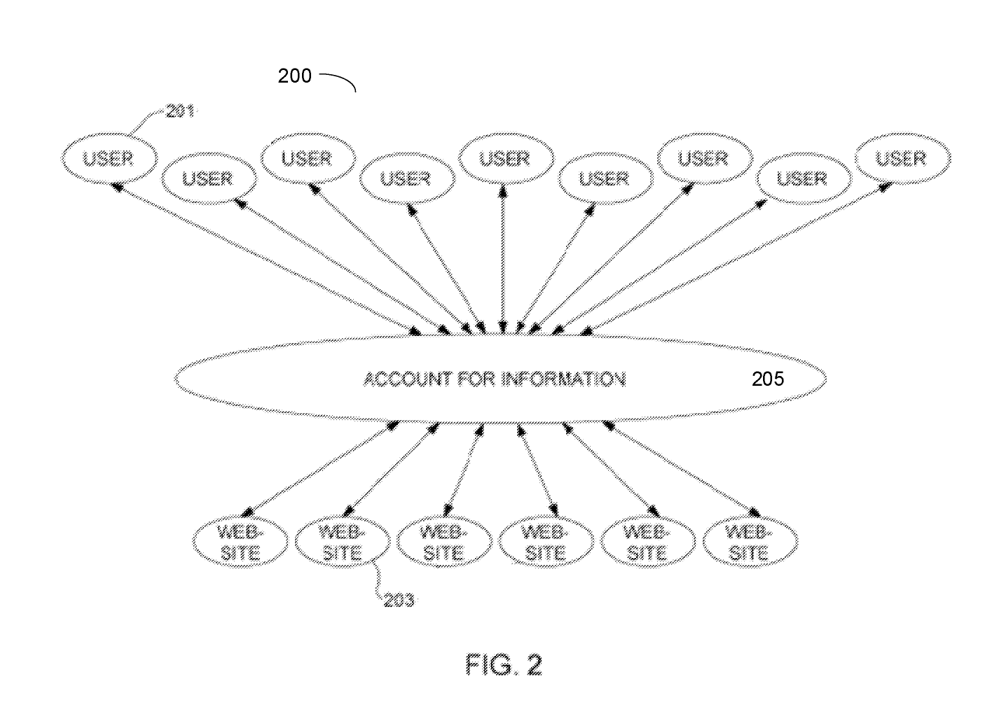

FIG. 2 presents an illustration of the exemplary flow of information via the Internet using an information account website, in accordance with an embodiment of the present invention.

An information flow 200 includes a multiplicity of information owners with a sampling denoted as an information owner 201, a multiplicity of websites with a sampling denoted as a website 203 and an information account website 205.

Information flow 200 may operate to enable communication between a multiplicity of users and a multiplicity of website devices.

Information owner 201 may seek to interact with a website or websites. Information owner 201 may desire to post and receive information via a website or websites.

Website 203 may operate as an Internet website for receiving and presenting information to a user or users or other website device or website devices.

Information account website 205 may operate as an intermediary processing device between a user or users and a website or websites.

For purposes of illustration, information owner 201 may communicate bi-directionally with information account website 205. Website 203 may communicate bi-directionally with information account website 205. Information owner 201 may communicate bi-directionally with website 203 via information account website 205.

In the present embodiment, information owner 201 (e.g., individuals, companies, etc.) may create accounts for their information via information account website 205.

Websites (e.g. website 203) may access the information accounts of their registered users (e.g. information owner 201) via information account website 205. This provides users (e.g. information owner 201) the capability of centrally administering their information such that the websites (e.g. website 203) may operate to access updated information for which they may be granted access. The updated information may be provided to users even if the users (e.g. information owner 201) do not further access the websites (e.g. website 203). Furthermore, the users (e.g. information owner 201) may operate to reconstruct the access and transfer of information.

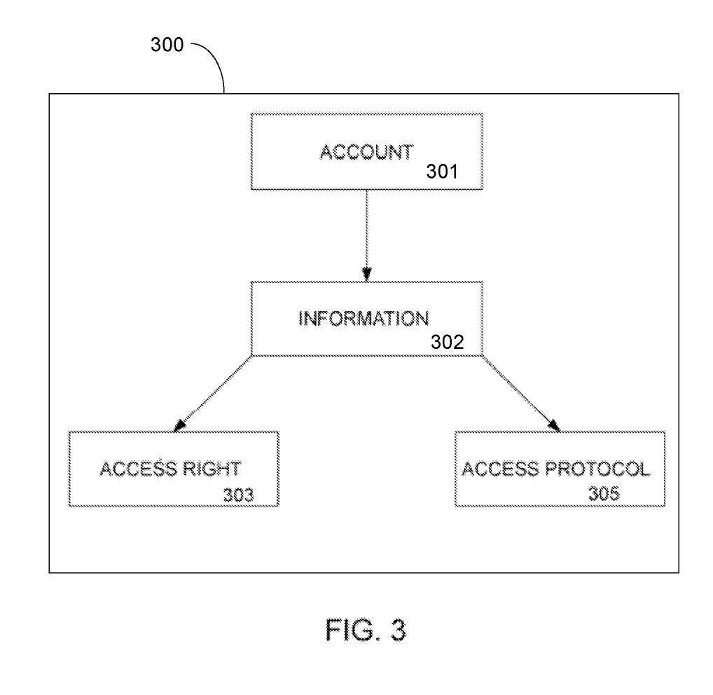

FIG. 3 presents a block diagram illustrating an exemplary account associated with an information account website, in accordance with an embodiment of the present invention.

An information account website 300 includes an information account 301, an information portion 302, an access right 303 and an access protocol 305.

Information account website 300 may operate in a similar manner as information account website 205 described with reference to FIG. 2.

Information account 301 represents an account of information associated with an owner.

Information portion 302 represents information associated with an account.

Access right 303 represents an access right associated with information. An entity may gain access or be rejected access to information based on access right 303. With access rights the user manages the access to an information. This access rights is a combination of “INFO” (web site will be informed when information is new or changed) “READ” (information can be accessed within online process e.g. shopping check out, web site is now allowed to store the information) “STORE” (web site is allowed to store the information on own storage system like database etc) “SYNCHRONIZE” (web site is allowed to synchronize information; store right is necessary) “DELETE” (web site has to delete the information out of own storage system like database etc).

Access protocol 305 represents a protocol associated with information. Access to the information may be accepted or rejected based on access protocol 305. This is a log (file or table in database), with the entries, who has accessed the information or to whom was the information transferred.

In the present embodiment, a user of information account website 300 may access information account 301. Furthermore, information account 301 has an associated unique identifier. Information account 301 may be associated with information portion 302 (one to many) in accordance with the user associated with information account 301. Information account 301 may also have other configurations. A non-limiting example of another configuration for information account 301 includes a profile. For information portion 302, associated with information account 301, access right 303 (zero to many) may be granted to other accounts. Access to information portion 302 associated with information account 301 may be logged to access protocol 305. Information portion 302 may include a label and an associated value (e.g. label =“Birthdate” value =“05/07/1970”). Furthermore information portion 302 can have a “valid from Timestamp” and/or a “valid to Timestamp”. Timestamps may be used for determining the timeframe for when an activity occurred.

A requester of information may administer information, for example, without limitation, a website URL, details of his/her address, etc. via an information account similar to information account 301 shown, by way of example, in FIG. 3. For this embodiment, the type for information account 301 may be denoted as a requester account. For security reasons, the requester of information may be requested to enter a personal identification number (PIN) for accessing his/her associated information. Furthermore, the information may be encoded prior to transferring it to storage and then decoded after being retrieved from storage. The PIN may be encoded with itself before being transferred to storage. Furthermore, the PIN may be supplied by the requester following authentication. Furthermore, the PIN may be retrieved from storage and decoded and compared to the entered PIN. If the decoded PIN matches the entered PIN, the requester may be granted access to his/her information account. Furthermore, in order to retrieve information from other accounts, the requester may be requested to supply a secret transfer key (STK) during the registration process. The STK is encoded with information associated with the account. Furthermore, the STK may be decoded. The STK may be requested and supplied when the requester seeks to retrieve information. If the entered STK matches the decoded version of the stored STK, the information that has been transferred to his/her account from other information accounts to which the requestor has access rights may be decoded using the STK. Following registration of a new requester, accounts may receive a notice associated with the new requester.

An owner of information may administer desired information such as, but not limited to, details of address, bank accounts, credit cards, etc. associated with an information account website via information account 301, described by way of example in FIG. 3. This type of account may operate as an owner account. Information may be transferred from one account to another. Furthermore, the information owner may select the destination or destinations for the information to be transferred. For example, information may be transferred in a similar manner as for currency. For security reasons the owner of information may operate to enter a PIN to access his/her associated information. Furthermore, the associated information may be encoded and may be decoded following retrieval from storage. The owner of information may grant access rights to his/her information to other accounts associated with information requesters. An owner of information may invite a requester of information to share his/her information on an information account website. Non-limiting examples of methods for communicating invitations for sharing information includes email, pop-up and SMS (Short Message Service).

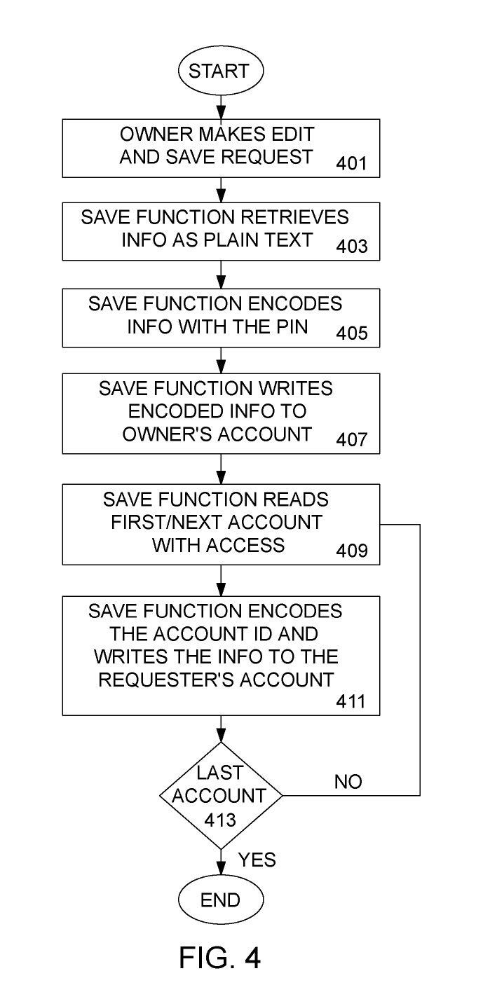

FIG. 4 presents a flowchart illustrating an exemplary process enabling an information owner to add and modify information associated with his/her account, in accordance with an embodiment of the present invention.

This process may be performed following the authentication and creation of an owner information account. Furthermore, authentication may include the owner supplying his/her PIN. In the present embodiment, the process begins when the owner performs an information editing and save request in a step 401. After this request is performed, a save function retrieves the owner's information in a step 403. A non-limiting example of the information retrieved includes text and images. Then, the save function may encode the information using the supplied PIN in a step 405. In a step 407, the encoded information may be transferred for storage to the information account associated with the owner. Then, in a step 409, the save function reads the first requester account that has access rights to the owner's account. In a step 411, the save function encodes the account identifier associated with the account and the information associated with the related STK and transfers the information for storage to the information account associated with the requester. Furthermore, the transferred information may be denoted as new or changed information. In a step 413, it may be determined if information has been transferred to accounts with access rights to the owner's account. If not, the save function returns to step 409 to process the next account with access rights. If so, the process terminates.

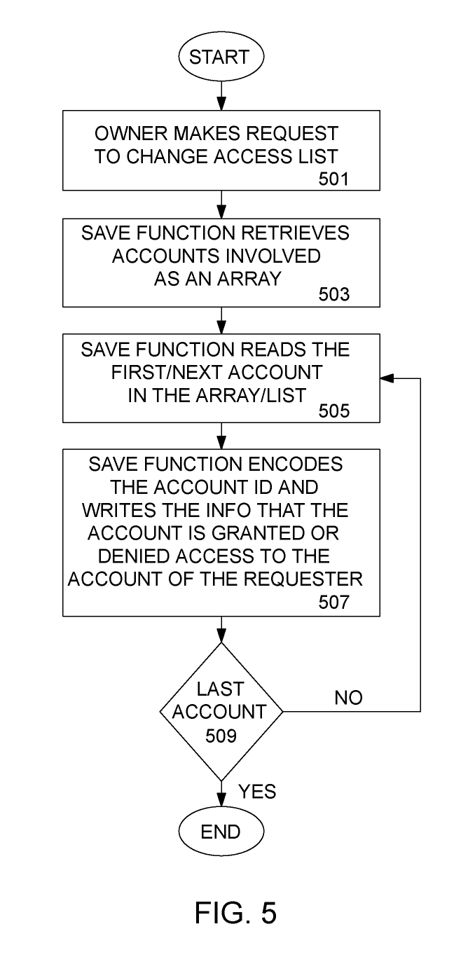

FIG. 5 presents a flowchart illustrating an exemplary process enabling an information owner with the capability to modify an access list associated with his/her account, in accordance with an embodiment of the present invention.

This process may be performed following the authentication and creation of an owner information account. As a non-limiting example, authentication may include verifying a supplied PIN. In the present embodiment, the process begins at a step 501 where the owner may perform a request to add accounts to or remove accounts from the access list associated with information to be supplied. Furthermore, step 501 may include saving modifications to access list. In a step 503, a save function retrieves information for associated accounts as an array or a list. In a step 505, the save function retrieves information associated for an account associated with the array. Then, in a step 507, the save function encodes the account identification associated with the owner account. Furthermore, information granted access to a requestor may be transferred for storage to the information account associated with the requestor. The save function determines if this is the last account in the array or list in a step 509. If not, the save function returns to step 505 to retrieve the next account in the array or list. If so, the process terminates.

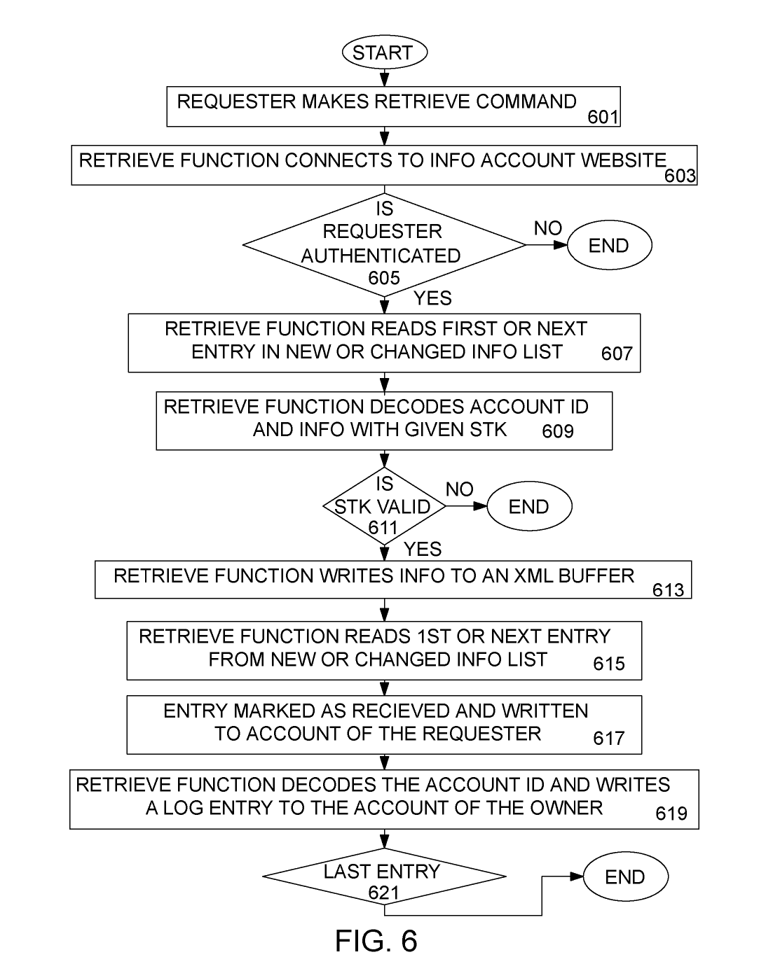

FIG. 6 presents a flowchart illustrating an exemplary process enabling an information requester with the capability to retrieve information from an information account website, in accordance with an embodiment of the present invention.

This process may be performed following the creation of an owner information account and subsequent authentication. During creation of the owner information account, requestor may be requested, via an application programming interface (API), to supply his/her PIN. The process begins at a step 601 where the requester performs a request to retrieve new or modified information. A retrieve function may be communicated via Internet to the information account website in a step 603. In a step 605 the retrieve function may operate to authenticate the requester's PIN and STK. If the requester is not successfully authenticated, the process terminates. If the requester is successfully authenticated, the retrieve function retrieves the first entry from a new or changed information list in a step 607. Then, in a step 609, the retrieve function, using the provided STK, decodes the account identification of the owner and the associated information. It may be determined if the STK is valid to decode the information in a step 611. If not, the process terminates. If so, the retrieve function communicates this information to an XML buffer in a step 613. In alternate embodiments, the information may be written to something other than an XML buffer such as, but not limited to, a file. In the present embodiment in a step 615, the retrieve function retrieves the first entry from the new or modified information list. In a step 617, the retrieve function denotes this entry as retrieved and transfers it to storage in the information account associated with the requester. Furthermore, a timestamp may be associated with the transferred information. In a step 619, the retrieve function decodes the account identification of the owner and the information with the given STK and transfers a log entry to storage associated with the information account for the owner. Owner may access this log for viewing information associated with which requesters have accessed the provided information. The retrieve function determines if this is the last entry in the list in a step 621. If not, the retrieve function returns to step 607 to read the next entry in the list. If so, the process terminates.

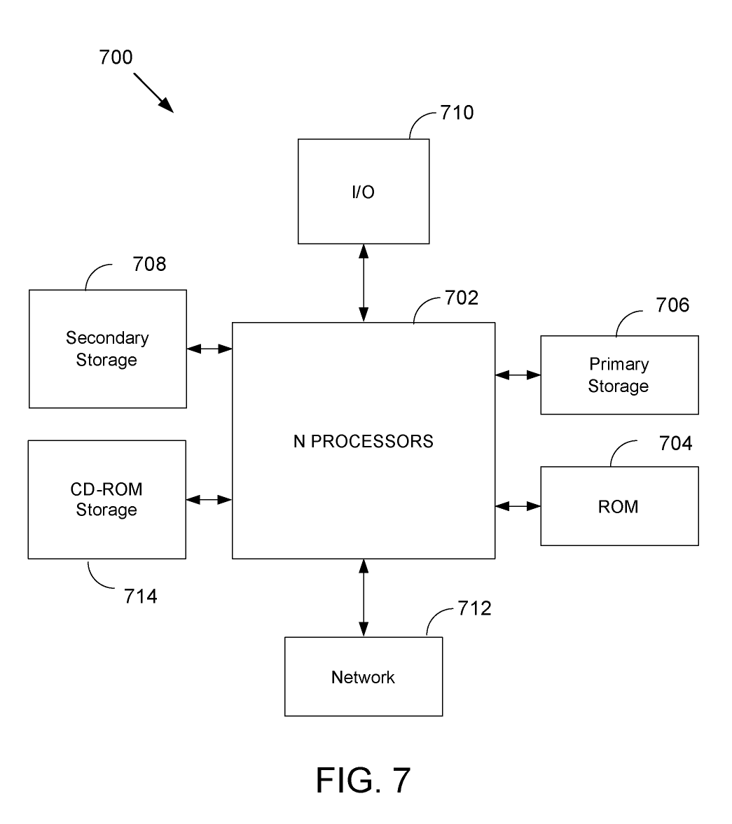

FIG. 7 presents an illustration of a typical computer system that, when appropriately configured or designed, may serve as a computer system 700 for which the present invention may be embodied.

Computer system 700 includes a quantity of processors 702 (also referred to as central processing units, or CPUs) that may be coupled to storage devices including a primary storage 706 (typically a random access memory, or RAM), a primary storage 704 (typically a read only memory, or ROM). CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 704 acts to transfer data and instructions uni-directionally to the CPU and primary storage 706 typically may be used to transfer data and instructions in a bi-directional manner. The primary storage devices discussed previously may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and typically may be used as a secondary storage medium such as a hard disk. It will be appreciated that the information retained within mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection shown generally as a network 712, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation:

a) For an owner of information adding/changing information (e.g. address, account banking, credit card number, phone number[s], email[s] etc.), the owner may operate to perform this operation via a single web site. A requester with access to this information may automatically receive the new information and may automatically have their associated information updated.

b) Web site may operate to analyze associated information. Non-limiting examples of uses for information analysis include research services.

c) Web site may operate to recommend contact and interaction with social web sites (e.g. facebook etc) for information owners providing information associated with purchasing behavior.

d) For information owners providing additional information associated with his/her social behavior (e.g. contact in Facebook, etc.), web site may operate to recommend products or services.

e) For an owner of information providing information associated with his/her needs (e.g. product, services, etc.), web site may operate to perform as an interface for consumer-to-business exchanges and interaction and for storing the associated information for owner and requester for global research service operations.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing an Internet based information distribution system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of network used. The systems described in the foregoing were directed to Internet based implementations; however, similar techniques may provide information distribution systems over networks other than the Internet such as, but not limited to, local area networks, private networks, etc. Non-Internet based implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising:
steps for accessing an account site for establishing at least one information account;
steps for establishing said information account by supplying at least a secret transfer key;
steps for entering information into said information account, where said information is viewable only by an owner of said information account;
steps for entering access permission to enable transfer of said information to an account of a requester;
steps for contacting the requester for at least making available said information; and
steps for communicating said secret transfer key to the requester where said secret transfer key is used by the requester to retrieve said information and a log entry of said retrieval is made into said information account.

2. The method as recited in claim 1, further comprising steps for accessing said information account for editing of said information.

3. The method as recited in claim 1, further comprising steps for accessing said information account to view said log entry.

4. A method comprising the steps of:
accessing an account site for establishing at least one information account;
establishing said information account by supplying at least a secret transfer key where said information account is associated with an account identifier;
entering information into said information account, where said information is encoded before storage into said information account and is viewable only by an owner of said information account;
entering access permission for at least one requester to enable transfer of said information to an account of the requester;
contacting the requester for at least making available said information; and
communicating said secret transfer key to the requester where said secret transfer key is used by the requester to retrieve said information where said information is decoded, transferred to an account of the requester and a log entry of said transfer is made into said information account.

5. The method as recited in claim 4, further comprising the step of accessing said information account for editing of said information where said edited information is encoded before storage.

6. The method as recited in claim 5, in which said edited information and said account identifier is further transferred to said account of the requester after said edited information and said account identifier is encoded.

7. The method as recited in claim 4, further comprising the step of accessing said information account to view said log entry.

8. The method as recited in claim 4, in which said account of the requester resides at said account site.

9. The method as recited in claim 4, in which said information remains viewable only by the owner of said information account during said decoding and transferring to said account of the requester.

10. The method as recited in claim 4, in which said step of establishing further comprises supplying a personal identifier for access to said information account.

11. The method as recited in claim 4, in which the requester supplies a personal identifier for access to said account of the requester.

12. A system comprising:
an account site being operable for establishing and maintaining a plurality of information accounts;
an owner information account established and maintained at said account site where said owner information account is operable for maintaining at least information that an owner desires to make available to selected requesters, said owner information account further being operable for encoding and storing said information, a secret transfer key, access permissions, and an account identifier, said owner information account further being operable for maintaining said information viewable only by the owner; and
a requester account established and maintained at said account site where said requester account is operable for receiving a transfer of information from said owner information account, said requester account further being operable for verifying a validity of a secret transfer key communicated to a user of said requester account from said owner where upon presentation of a valid secret transfer key by the user, said requester account is further operable for decoding said information and recording a log entry in said owner information account of a transfer of at least part of said information.

13. The system as recited in claim 12, in which said requester account is further operable for decoding said account identifier to determine a location for said log entry.

14. The system as recited in claim 12, in which said owner information account is further operable for enabling the owner to edit said information.

15. The system as recited in claim 12, in which said owner information account is further operable for enabling the owner to edit said access permissions.

16. The system as recited in claim 14, in which said edited information and said account identifier is further transferred to said requester account after said edited information and said account identifier is encoded.

17. The system as recited in claim 12, in which said owner information account is further operable for enabling the owner to view said log entry.

18. The system as recited in claim 12, in which said information remains viewable only by the owner of said information account during transferring to said requester account.

19. The system as recited in claim 12, in which the owner supplies a personal identifier for access to said information account.

20. The system as recited in claim 12, in which the requester supplies a personal identifier for access to said requester account.
